(19) United States
(12) Patent Application Publication
(10) Pub. No.: US 2010/0175589 A1
(43) Pub. Date: Jul. 15, 2010

(54) DUAL COMPONENT SYSTEM CONTAINING RETARDED ALUMINOUS CEMENT WITH INSTANTANEOUS INITIATION

(75) Inventors: Eric Charpentier, Villefontaine (FR); Herve Fryda, Meyrie (FR)

Correspondence Address: YOUNG & THOMPSON, 209 Madison Street, Suite 500, Alexandria, VA, 22314, US

(73) Assignee: KERNEOS, NEUILLY SUR SEINE (FR)

(21) Appl. No.: 12/666,861

(22) PCT Filed: Jun. 19, 2008
(86) PCT No.: PCT/FR08/51119

§ 371 Date: Dec. 28, 2009

(30) Foreign Application Priority Data
Jun. 28, 2007 (FR) 0756116

(51) Int. Cl. C04B 28/06

(52) U.S. Cl. 106/696; 106/692

(57) ABSTRACT

A ready-for-use dual-component system includes a portion (A) containing retarded aqueous-phase aluminous cement and an aqueous phase portion (B) for initiating the curing process. The portion (A) further includes boric acid or a salt thereof, at least one super-plasticizer and water. The portion (B) includes an initiator and water. The dual-component system meets the following requirements: a) the initiator includes uniquely lithium salts and contains a mixture of lithium hydroxide and at least another water-soluble lithium salt; the total mass of lithium in the portion (B) is such that, after mixing with the portion (A), ranges from 0.5 wt % to 2 wt % relative to the weight of aluminous cement in the portion (A); and c) the mass of lithium in the portion (B) added by the lithium hydroxide is such that, after mixing with the portion (A), ranges from 0.1 wt % to 1 wt % relative to the weight of aluminous cement in the portion (A).

The invention relates to a ready-for-use dual-component system including a portion (A) containing retarded aqueous-phase aluminous cement and an aqueous phase portion (B) for initiating the curing process. The portion (A) further includes boric acid or a salt thereof, at least one super-plasticizer and water. The portion (B) includes an initiator and water. According to the invention, the dual-component system meets the following requirements: a) the initiator includes uniquely lithium salts and contains a mixture of lithium hydroxide and at least another water-soluble lithium salt, preferably a lithium sulphate or carbonate; the total mass of the lithium element (Li) in the portion (B) is such that, after mixing with the portion (A), it ranges from 0.5 wt % to 2 wt % relative to the weight of aluminous cement in the portion (A), preferably from 0.8 wt % to 1.3 wt %; and c) the mass of the lithium element (Li) in the portion (B) added by the lithium hydroxide is such that, after mixing with the portion (A), it ranges from 0.1 wt % to 1 wt % relative to the weight of aluminous cement in the portion (A), preferably from 0.15 wt % to 0.4 wt %.

The present invention concerns a ready-for-use dual-component system comprising a part A based on aluminous cement and a part B comprising a lithium-based initiator. The system cures in less than 5 minutes after mixing of the two parts. More particularly, the invention concerns a dual-component system composed of two parts, A and B, which are of mineral nature and non corrosive, in aqueous phase and individually stable for at least 6 months. The invention also concerns a dual-component capsule. Finally, the invention specially applies to applications in which it is desired to glue or to seal materials.

Many dual-component systems exist, in which each of the components is intended to be mixed to initiate the curing reaction. When a very fast curing is desired, in particular right from 5 minutes, crosslinkable organic resins are generally used, which are kept in suspension in a non-aqueous solvent and mixed with a catalyst at the time of coating. It is notably the case of epoxy adhesives and polyester-based sealing mortars. However, such systems have the drawback of being polluting, expensive and potentially hazardous for the user.

To compensate for these drawbacks, partially or predominantly mineral systems have been developed.

EP 0,241,230 and EP 0,113,593 and the French utility certificate FR 2,763,937 disclose dual-component systems including a part A based on aqueous-phase aluminous cement, retarded by several months by boric acid or a salt thereof in suspension in water, and a part B for initiating the curing process. Part B comprises a material able to “release” the retarded aluminous cement and a catalyst for accelerating the cement setting.

The French utility certificate FR 2,763,937 recommends the use of 3 to 33 wt % of hydrated lime in part B and the use of a lithium salt as a catalyst. This document provides no information about the type of lithium salt or about the required quantities. Moreover, no specific example of composition or property is described.

EP 0,241,230 and EP 0,113,593 provide a very fast curing process, with an initial-set time shorter than 5 minutes and a mechanical compressive strength after 30 minutes of 2 to 18 MPa depending on the mentioned examples. On the other hand, part B has high contents of corrosive chemical elements such as lime or lithium hydroxide, which makes the handling potentially hazardous. These patents actually disclose the use as a catalyst of a lithium salt chosen from lithium sulfate, carbonate or hydroxide. All the examples disclosed in these documents comprise about 50% of lime as a releasing material in part B. Among the lithium salts, only the lithium hydroxide is exemplified as a catalyst, used in levels of at least 3.9 wt % of part B in the mentioned examples.

EP 0,081,385 also discloses a dual-component system including a part A based on aqueous-phase aluminous cement and a part B for initiating the curing process. The setting of part A may be retarded during more than six months by using a set inhibitor, which may be boric acid. Part B comprises an initiator or an initiator combination. In the mentioned list of initiators, lithium salts, especially lithium hydroxide, sulfate and carbonate, are found. Part B may be in aqueous suspension form.

All the examples using a lithium salt further comprise another initiator such as gypsum, hydrated lime or calcium carbonate. This other initiator is predominantly present in part B.

In the mentioned examples, the first setting-time is 4 hours or more, which does not permit to say that such a system has a fast setting in the first minutes. Only Example 8 mentions a curing after 30 minutes, but with the adding in part B of a significant quantity of a compound of the hydrated-lime type, which creates an additional drawback related to the toxicity of this type of product, and thus to the risks incurred when handling such systems.

Accordingly, a need exists for a mineral dual-component system as efficient as the dual-component system based on organic resin, but without the drawback of being toxic for the environment and/or hazardous for persons who handle them.

As understood herein, “as efficient as” means a system having the following properties:
long shelf life, i.e. of at least one month, better of two months or more, and ideally of at least 6 months, so as to protect the system from the storing or supply delays,
instantaneous initiation with an initial-set time shorter than 5 minutes after mixing of the two parts,
good mechanical strength properties, typically a compressive strength of at least 5 MPa after 15 minutes,
non toxicity for persons having to handle the system,
non-polluting system.

Within the meaning of the invention, the “shelf life” is the time during which a component stays in the form of a more or less fluid aqueous suspension of solid products, capable of coming back to the aqueous-suspension state through a simple mechanical stirring, without setting.

The above-mentioned problems are solved according to the invention by a dual-component system including a part A based on retarded aqueous-phase aluminous cement and a part B in aqueous-phase for initiating the curing process, part A further including boric acid or a salt thereof, at least one superplasticizer and water and part B comprising an initiator and water, and meeting the following requirements:

a) the initiator is made of only lithium salts and comprises a mixture of lithium hydroxide and at least one other water-soluble lithium salt, preferably a lithium sulphate or carbonate,

b) the total weight of lithium element (Li) in part B is such that, after mixing with part A, it ranges from 0.5 wt % to 2 wt % based on the weight of aluminous cement in part A, preferably from 0.8 wt % to 1.3 wt %, and

c) the weight of the lithium element (Li) in part B provided by the lithium hydroxide is such that, after mixing with part A, it ranges from 0.1 wt % to 1 wt % relative to the weight of aluminous cement in part A, preferably from 0.15 wt % to 0.4 wt %.

In the present application, “aluminous cement” refers to a hydraulic binder whose alumina content ranges from 30 to 80 wt % relative to the total weight of the binder.

Preferably, parts A and B further include mineral fillers.

Parts A and B have a pasty to fluid aspect according to their compositions.

The product obtained by mixing parts A and B has an initial-set time shorter than 5 minutes and reaches a mechanical compressive strength of at least 5 MPa within 15 minutes, and preferably of 10 MPa within 15 minutes.

The association of lithium hydroxide and at least one other water-soluble lithium salt, according to the selected proportions, provides both the aluminous cement “release” and the mixture curing acceleration in a synergic manner and in the absence of lime or another initiator.

This particular association of lithium hydroxide and at least one other water-soluble lithium salt shows a surprising effect.

Indeed, in the complete absence of lithium hydroxide, the initial-set time becomes longer than 5 minutes and the ability to develop a mechanical strength within the first 15 minutes is lost. On the other hand, an excess of lithium hydroxide induces a loss of mechanical strength both in the short term (15-30 minutes) and in the longer term (several days). Such a negative effect on the mechanical strength is also observed when adding sodium hydroxide.

Accordingly, it is necessary to have a minimum proportion of lithium hydroxide in order to obtain an instantaneous initiation. This quantity provides neutralization of the boric acid in excess and thus release of the aluminous cement hydration.

Without being linked by any theory, this negative effect is thought to be attributable to a blocking of the cement particle hydration by fast formation of a basic gel on the surface thereof. On the other hand, beyond the minimum dose of lithium hydroxide introduced to release the aluminous cement, it is better to increase the quantity of lithium ions so as to increase the number of nucleation sites for the hydrate formation, wherein these ions can be provided by other lithium salts such as the sulfate or the carbonate. But, again, a limit exists that does not have to be exceeded on pain of negative effect on the mechanical strength. This negative effect may be attributed to a modification of the microstructure by the too great number of germs.

Consequently, the advantageous results of the invention are obtained only by respecting a particular range of lithium hydroxide concentration as well as a particular maximum value of total lithium. Indeed, using the specific combination of lithium hydroxide and at least one other water-soluble lithium salt, the quantities of lithium hydroxide are controlled while keeping a sufficiently high quantity of lithium to allow an efficient acceleration of the system curing process. A system is thus obtained that is instantaneously initiated while keeping a high strength in longer term.

Within the meaning of the invention, “instantaneous initiation” means obtaining, after mixing of the two parts A and B, an initial-set time shorter than 5 minutes, as measured by the Vicat-needle method. The initial-set time is determined by the instant of time when the Vicat needle, a needle of 1 mm² in section and 300 g in weight, does not sink anymore deep into a paste pellet made of the mixture A+B. The modalities for measuring the initial-set time are described in the standard NF EN 196-3.

It is estimated that the system has good strength properties when a mechanical compressive strength of at least 5 Mpa is obtained within 15 minutes, as measured based on the standard NF EN 196-1.

Consequently, the dual-component system object of the invention provides, for similar applications, curing rates comparable to those of the above-mentioned organic systems, but the essentially mineral composition thereof makes it far less toxic and very little polluting for the environment. Moreover, its performances are obtained for a lower cost than that of the organic systems used in the prior art.

Generally, the dual-component system of the invention thus appears as an economical and an ecological alternative to all applications implementing a ready-for-use paste or liquid that sets in less than 5 minutes after being mixed with an initiator. Examples are the anchoring or sealing systems.

Moreover, it has also been surprisingly noticed that, in the system of the invention, the best results in terms of strength and initiation, i.e. an optimum efficiency, are obtained for a quantity of lithium hydroxide in part B lower than 1 wt % based on the total weight of part B. Now, if lithium hydroxide is itself corrosive, i.e. it causes chemical burns in contact with skin or eyes, corrosiveness of a composition comprising lithium hydroxide decreases with the content thereof. Thus, according to the European Directive 1999/45, a preparation is corrosive if it contains more than 5% of hydroxide, irritant if the content is between 1% and 5%, and without risk if the content is lower than 1%.

Consequently, the dual-component system of the invention has the additional advantage to be non-harmful for the persons handling it or at the very least far less harmful than the other existing dual-component mineral systems. By way of comparison, it can be mentioned the systems described in EP 0,241,230, in which part B comprises 53.1% of hydrated lime and 6.6% of lithium hydroxide. Those systems are thus particularly corrosive because of the substantial levels of lime and lithium hydroxide.

Accordingly, the invention provides a dual-component system with a shelf life longer than six months, which can be instantaneously initiated.

In an advantageous embodiment, the invention further comprises the following characteristics, taken alone or in combination.

Parts A and B have the following weight compositions.

Part A:
60 to 80 wt % of aluminous cement,
1 to 3 wt % of boric acid or a salt thereof,
5 to 10 wt % of mineral fillers,
1 to 5 wt % of superplasticizer,
13 to 18 wt % of water.

Part B:
2.5 to 6.5 wt % of anhydrous lithium sulfate (Li₂SO₄),
0.4 to 1 wt % of anhydrous lithium hydroxide (LiOH),
75 to 90 wt % of mineral fillers,
5 to 15 wt % of water.

The weight ratio between part A and part B (A/B) is preferentially comprised between 2/1 and 1/2. Preferably, the composition of the mixture comprises 50 wt % of part A and 50 wt % of part B.

According to a preferred embodiment, the aluminous cement contained in part

A is retarded by boric acid or a salt thereof present in a content of 1 to 3%, preferably 1 to 2.3%, and even better of 2 wt % relative to the total weight of aluminous cement. Boric acid is preferably used.

The presence of a superplasticizer, which is an organic compound, in levels lower than or equal to 5% does not change the basically mineral nature of the system according to the invention. Preferably, the dual-component system according to the invention thus comprises at most 5 wt % of an organic compound. The superplasticizers are preferably chosen in the family of polyphosphonate polyox and polycarbonate polyox PCP, and the mixtures thereof. The superplasticizers of the polycarbonate polyox type are known compounds and are notably described in the patents US20030127026 and US20040149174. Polyphosphonate polyoxs are notably described in the patents FR-A-2810314 and FR-A-2696736, as well as FR-A-2689895. Those superplasticizers are commercially available products.

Preferably, the proportion of lithium hydroxide in part B is lower than 1 wt %.

According to an advantageous embodiment, parts A and B are in paste form. The pasty character limits the risk of sagging at the time of mixing the two parts and, consequently, the risk of contact with or projection to persons that handle them. Accordingly, the little corrosive character of parts A and B and the consistency of the dual-component system of the invention both contribute to its innocuousness.

The mineral fillers may be chosen for example among silica smoke, blast furnace slag, fly ashes, limestone fillers, sand, crushed stones, gravels and/or pebbles.

Preferentially, the mineral fillers of part A and B are chosen so as to obtain a particle size complementary to that of the aluminous cement. The aluminous cement particle size depends on the fineness thereof, but it can be considered in general that the proportion of 5-μm-undersize is lower than 40% and that the proportion of 100-μm-undersize is higher than 90%. The fillers of part A are preferably chosen so as to have a particle size smaller than that of the cement, i.e. with a maximum diameter of particle smaller than 5 μm. The fillers of part A are preferentially chosen among the silica smoke and/or a filler meeting the particle size requirement. The mineral fillers of part B are preferentially chosen so as to have a particle size greater than that of the cement, i.e. at least 80 wt % of filler particles have a minimum diameter of particle equal to or greater than 100 μm, wherein the maximum diameter depends on the intended application.

For example, for applications such as anchoring systems, the mineral fillers preferably have a maximum diameter (Dmax) of at most 1 mm.

The proportions of water in the two parts are chosen so that the water to aluminous cement weight ratio (E/CAC) in the product obtained by mixing parts A and B is lower than 0.65, preferably lower than 0.4.

According to a preferential embodiment, parts A and B are free from lime, sodium hydroxide or any other corrosive product other than lithium hydroxide.

Preferably, the pH of the product obtained by mixing parts A and B is higher than 12.

In the dual-component system of the invention, only part A is liable to set, because the components of part B can not react with each other. Consequently, the shelf life of the dual-component system of the invention will depend uniquely on the shelf life of part A. Preferably, parts A and B of the dual-component system according to the invention have a shelf life of at least six months.

An object of the invention is also a dual-component capsule comprising a part A based on retarded aluminous cement and a part B for initiating the curing process. Parts A and B are such as defined above.

Finally, the invention concerns the use of the dual-component system as a sealing material or as a material for making gluing works.

According to a preferred embodiment, the setting retarder used in part A of the invention is boric acid and/or a boric-acid salt. The boric-acid salts may be chosen among zinc borate, sodium borate and mixtures thereof. However, boric acid is preferentially used.

The retarder may be present in contents of 1 to 3 wt % based on the total weight of aluminous cement. It is considered that, to obtain a shelf life of at least six month for part A, 1 to 2 wt % of retarder based on the weight of aluminous cement is needed. It seems that adding boric acid or a derivative thereof permits, via the formation of calcium borate, to strongly limit the solubilization of the calcium aluminate(s) in water. The cement hydration that leads to the curing of the mixture is thus momentarily stopped by adding the boric-acid derivative.

When the initiator, made of the mixture according to the invention of lithium hydroxide and at least one other water-soluble lithium salt, is mixed with part A comprising the aluminous cement, the pH of the medium increases, which made the aluminous-cement-setting retarder inoperative. The hydration reaction of the calcium aluminates is thus released. This hydration reaction seems to be strongly catalyzed by the lithium. Thanks to the combined action of lithium hydroxide and at least one other water-soluble lithium salt, both an instantaneous setting and a preservation of good mechanical properties are thus obtained. Coupling lithium hydroxide to a lithium salt of the sulfonate or carbonate type makes it possible to ensure the presence of significant quantities of lithium and to therefore initiate the nucleation and massive precipitation of the whole system.

According to an embodiment, part A and part B are in the form of a paste in which the components and mineral fillers are kept in a stable and homogeneous suspension thanks to the presence of little water.

The role of the mineral fillers is to adjust the final performance and to make the system economically competitive. Indeed, by optimizing the particle size, it is possible to minimize the necessary quantity of water, and more particularly the ratio water/aluminous cement. The setting rate acceleration is thus furthermore favored.

The choice of silica smoke allows minimizing furthermore the weight ratio water/CAC.

Within the meaning of the invention, the “silica smoke” is silica in powder form, whose particles have a micrometric or nanometric size.

Indeed, the smaller size of the silica-smoke particles and possibly their spherical form allow reducing the proportion of water before dilatancy. The dilatancy corresponds to a strong increase of the viscosity during the mixing operation.

An optimum dual-component system is obtained by combining the following characteristics:
using lithium hydroxide and at least one other water-soluble lithium salt, preferably a lithium sulfate or carbonate, in specific proportions, so as to obtain an initial-set time shorter than 5 minutes and to keep good mechanical properties in longer term,
optimizing the particle size by choosing mineral fillers having a particle size complementary to that of the aluminous cement, with in particular the presence of silica smoke in part A,
choosing Dmax=1 mm for the mineral fillers,
distributing the fillers in a specific manner in parts A and B.

In an advantageous embodiment of the invention, the dual-component system is used for the fabrication of anchoring capsules.

Thanks to the invention, it is thus possible to develop an ultra-fast solution for the application of anchoring capsule in the mining industry. The anchoring capsules are intended to be inserted into a borehole in the rock of the “roof” of a newly dug gallery. These capsules are made of two sealed compartments comprising part A based on aluminous cement and part B containing the initiator. After insertion of the capsule into the hole, a metal rod is rotation-inserted thereinto. This rod tears the compartments of the capsule and permits the two parts to mix together. A beginning of curing occurs that permits the rod to fix to the rock. A bolt at the end of the rod is then tightened to compress the rock. This compression allows the gallery to be secured and the operations to be continued.

The present invention perfectly matches with the requirements for anchoring systems because of the following advantages:
capsule shelf life of at least 6 months at 20° C.,
initial-set time shorter than 5 minutes and compressive strength of 15 MPa 15 minutes after mixing of the two compartments,
“thixotropic” behavior of the mixture, i.e. the mixture is fluid enough to well coat the metal rod during the rotation thereof, but with a certain flowing threshold at rest so as to avoid leakages,
absence of products corrosive for skin and eyes.

The existing capsules are made of expensive acrylic resins. The interest of developing an essentially mineral capsule based on aluminous cement is a significant reduction of cost.

Part A may be prepared as follows. The boric-acid salt or boric acid is added in water, and mixed during at least 15 minutes. The cement and mineral fillers are then added, and the mixing operation is continued during still 15 minutes.

Part B may be prepared by simply mixing the different components constituting this part.

The following example illustrates the invention without thereby limiting it.

### EXAMPLE

The proportions that are given are expressed in weight.

Part A is prepared by mixing the following components.

Composition of Part A:

| | |
|---|---|
| Water | 15.24% |
| Boric acid | 1.45% |
| OP 200 | 0.99% |
| P 180 | 1.98% |
| Ternal HR ® | 72.60% |
| FS RW Fuller ® | 7.74% |

Ternal HR ® is an aluminous cement product marketed by KERNEOS.
PREMIA 180 ® (P 180) and OPTIMA 200 ® (OP 200) are two superplasticizer products marketed by CHRYSO.
FR RW Fuller is silica smoke product marketed by RW Silicium GmbH.

The mixing protocol is as follows:
weighting out the necessary quantity of water and introducing the water into a mixing bowl,
slowly adding the boric acid under stirring,
continuing mixing at reduced speed during 25 minutes until the boric acid is dissolved,
adding the superplasticizer and mixing at the same speed during 2 minutes,
adding half the mass of the CAC, accurately weighted out, and mixing until complete incorporation of CAC, then adding the rest of CAC following the same protocol,
proceeding similarly with the silica smoke,
continuing mixing at reduced speed during 2 minutes, then increasing the mixing speed and mixing during 2 minutes.

Part B is prepared by mixing the following components.

Composition of Part B:

| | |
|---|---|
| Water | 11.61% |
| Li₂SO₄ | 4.04% |
| Anhydrous LiOH | 0.62% |
| Palvadeau sand 0.315-1 mm | 42.90% |
| Durcal 130 ® | 40.83% |

Durcal 130 ® is a limestone filler product marketed by OMYA.

The mixing protocol is as follows:
weighting out the necessary quantity of water,
adding the lithium sulfate into water and stirring with a magnetic stirrer until the whole is dissolved,
adding the lithium hydroxide into the solution and stirring with a magnetic stirrer until the whole is dissolved,
mixing the dry materials (Palvadeau sand and Durcal 130) during 5-10 minutes at reduced speed in a planetary mixer,
adding the solution of lithium salts and mixing at reduced speed during 10 minutes, then increasing the speed and mixing during 5 minutes,
checking the mixture homogeneity (in particular at the bottom of the container) and, if the mixture is not homogeneous, mixing again during 2 minutes at high speed.

Part A (56%) and part B (44%) are mixed together during 30 seconds with a mixer. The characteristics of the obtained mixture are the following:
initial-set time<5 minutes, as measured by Vicat needle,
compressive strength, as measured on prismatic test specimens of 20*20*100 mm, placed under vibration:

| Time (minutes) | Compressive strength (MPa) |
|---|---|
| 10 | 8 |
| 18.3 | 17.2 |
| 32.9 | 20.6 |
| 46.3 | 21.5 |
| 121.5 | 25.5 |
| 1 day | 35.9 |
| 7 days | 50.49 |

This example clearly illustrates that the systems according to the invention set in less than 5 minutes and that the compressive strength is 8 MPa after only 10 minutes. The system according to the invention actually provides a compressive strength of about 15 MPa within 15 minutes.

1. Dual-component system comprising a part A based on retarded aqueous-phase aluminous cement and a part B in aqueous-phase for initiating the curing process, part A further including boric acid or a salt thereof, at least one superplasticizer and water and part B including an initiator and water, characterized in that:
a) the initiator is only made of lithium salts and comprises a mixture of lithium hydroxide and at least one other water-soluble lithium salt, preferably a lithium sulphate or carbonate,
b) the total weight of lithium element (Li) in part B is such that, after mixing with part A, it ranges from 0.5 wt % to 2 wt % based on the weight of aluminous cement in part A, preferably from 0.8 wt % to 1.3 wt %, and
c) the weight of the lithium element (Li) in part B provided by the lithium hydroxide is such that, after mixing with part A, it ranges from 0.1 wt % to 1 wt % based on the weight of aluminous cement in part A, preferably from 0.15 wt % to 0.4 wt %.

2. Dual-component system according to claim 1, characterized in that parts A and B further comprise mineral fillers.

3. Dual-component system according to claim 1, characterized in that, after mixing of the two parts A and B, an initial-set time shorter than 5 minutes is obtained, as measured by the Vicat-needle method.

4. Dual-component system according to claim 1, characterized in that the product obtained by mixing parts A and B reaches a mechanical compressive strength of at least 5 MPa within 15 minutes, and preferably of 10 MPa within 15 minutes.

5. Dual-component system according to claim 1, characterized in that the weight composition of part A is as follows:
60 to 80 wt % of aluminous cement,
1 to 3 wt % of boric acid or a salt thereof,
5 to 10 wt % of mineral fillers,
1 to 5 wt % of superplasticizer,
13 to 18 wt % of water.

6. Dual-component system according to claim 1, characterized in that the weight composition of part B is as follows:
2.5 to 6.5 wt % of anhydrous lithium sulfate (Li₂SO₄),
0.4 to 1 wt % of anhydrous lithium hydroxide (LiOH),
75 to 90 wt % of mineral fillers,
5 to 15 wt % of water.

7. Dual-component system according to claim 1, characterized in that the weight ratio between part A and part B (A/B) is comprised between 2/1 and 1/2, preferably 1/1.

8. Dual-component system according to claim 1, characterized in that boric acid or a salt thereof is present in a content of 1 to 3%, preferably 1 to 2.3%, and even better of 2 wt % based on the total weight of aluminous cement.

9. Dual-component system according to claim 1, characterized in that the dual-component system comprises at most 5 wt % of an organic compound.

10. Dual-component system according to claim 1, characterized in that the proportion of lithium hydroxide into part B is lower than 1 wt %.

11. Dual-component system according to claim 1, characterized in that parts A and B are in paste form.

12. Dual-component system according to claim 1, characterized in that the fillers of part A have a maximum diameter of particle smaller than 5 μm, and at least 80 wt % of the filler particles of part B have a minimal diameter of particle equal to or greater than 100 μm.

13. Dual-component system according to claim 1, characterized in that the fillers of part A are chosen among silica smoke and/or a filler.

14. Dual-component system according to claim 1, characterized in that the fillers of parts A and B have a maximum diameter (Dmax) of 1 mm.

15. Dual-component system according to claim 1, characterized in that the proportions of water in the two parts are chosen so that the water to aluminous cement weight ratio (E/CAC) in the product obtained by mixing parts A and B is lower than 0.65, preferably lower than 0.4.

16. Dual-component system according to claim 1, characterized in that the pH of the product obtained by mixing parts A and B is higher than 12.

17. Dual-component system according to claim 1, characterized in that parts A and B have a shelf life of at least six months.

18. Dual-component capsule comprising a part A based on retarded aluminous cement and a part B for initiating the curing process, characterized in that parts A and B are such as defined in claim 1.

19-20. (canceled)
